(19) United States
(12) Patent Application Publication
(10) Pub. No.: US 2006/0262040 A1
(43) Pub. Date: Nov. 23, 2006

(54) PLASMA DISPLAY DRIVING APPARATUS AND DRIVING METHOD

(75) Inventors: Beong Ha LIM, Gumi-si (KR); Hyun Tae HWANG, Changwon-si (KR); Hee Jang ANH, Ulsan-si (KR)

Correspondence Address: FISH & RICHARDSON P.C., P.O. BOX 1022, MINNEAPOLIS, MN, 55440-1022, US

(73) Assignee: LG ELECTRONICS INC., Seoul (KR)

(21) Appl. No.: 11/419,679

(22) Filed: May 22, 2006

(30) Foreign Application Priority Data
May 23, 2005 (KR) 10-2005-0043164

(51) Int. Cl. G09G 3/28

(52) U.S. Cl. 345/63

(57) ABSTRACT

A plasma display driving apparatus and a driving method thereof are provided. The plasma display driving apparatus includes a panel formed with a scan electrode, a sustain electrode, and an address electrode; and a driver for varying a rising time or falling time of sustain pulses applied to at least one of the scan electrode and the sustain electrode when the same image is repeatedly displayed in the panel during at least two frames. The driving method of a plasma display driving apparatus includes applying data pulses to an address electrode during an address period; and applying sustain pulses to at least one of a scan electrode and a sustain electrode during a sustain period, wherein a rising time or falling time of sustain pulses applied during the first frame is dissimilar to a rising time or falling time of sustain pulses applied during the second frame when the same image is repeatedly displayed in the panel during at least two frames. Therefore, intensity of a discharge is weakened by reducing the number of a sustain discharge and at the same time, setting a rising time or falling time of sustain pulses to be long when the same image is displayed during a fixed time, so that deterioration of a phosphor is prevented and an afterimage and brightness are improved.

### BACKGROUND OF THE INVENTION

1. Field of the Invention

The present invention relates to a plasma display driving apparatus and a driving method thereof, and more particularly, to a plasma display driving apparatus that can prevent deterioration of a phosphor and improve an afterimage and brightness and a driving method thereof.

2. Description of the Background Art

FIG. 1 is a view illustrating a plurality of driving circuit board positioned on a rear surface of a panel in a conventional plasma display apparatus.

A plasma display apparatus is a display apparatus that uses light generating when vacuum ultraviolet rays (VUV) generating by discharging a gas within a panel collide with a phosphor within the panel. The plasma display apparatus includes a module 6 provided with discharge cells and electrodes for performing a discharge and a plurality of driving circuit boards for driving the plasma display apparatus.

The module 6 performs a function as a support plate for attaching the driving circuit board. The circuit board for driving the plasma display apparatus basically includes a control board 1 for receiving an image signal and generating a control signal to control a discharge of the plasma display apparatus, an address board 2 for generating an address signal by the control signal that is generated in the control board, a scan board 3 for generating a scan signal, and a sustain board 4 for generating a sustain signal.

The plasma display apparatus includes a plurality of address electrodes (X) arranged in a column direction and a plurality of scan electrodes (Y) and sustain electrodes (Z) arranged in a row direction. A waveform as shown in FIG. 2 is applied to display an image on a screen by performing a discharge in the address electrode, the scan electrodes, and the sustain electrode.

FIG. 2 is a diagram illustrating a driving waveform of a conventional plasma display apparatus. Referring to FIG. 2, the driving waveform includes a reset period (R), an address period (A), and a sustain period (S). The reset period is a period of initializing a discharge cell by applying a high voltage and in the reset period, a high voltage of 250V or more is applied to the scan electrode.

Image writing is performed in each discharge cell in the address period (A). Data pulses are applied to the address electrode (X) and scan pulses are applied to the scan electrode (Y), whereby an address discharge is generated and a cell for performing a discharge during a sustain period (S) is selected.

As a pulse signal (Vs) of opposite polarity is alternatively applied to the scan electrode (Y) and the sustain electrode (Z) in the sustain period (S), whereby a sustain discharge is generated and thus a screen is displayed.

If continuously moving images are displayed in a plasma display apparatus, a driving waveform consisting of a reset period (R), an address period (A), and a sustain period (S) is applied as described above, data writing is performed during the address period depending on the image data, and a discharge is generated during a sustain period, whereby a screen is displayed.

However, in a case of a still image in which one image is uniformly displayed, the same frame is continuously displayed and each subfield constituting the frame has the same waveform in every frame.

Therefore, even if initialization of a discharge cell is performed during the reset period (R), the discharge cell performs an identical discharge in every frame. Accordingly, priming particles for performing a discharge increase in a specific discharge cell in which a discharge is performed, thereby aggravating deterioration of a phosphor. Accordingly, a lifetime of a plasma display apparatus is shortened and priming particles are excessively generated in a cell in which a discharge is performed. Therefore, when other screen is displayed, an afterimage problem in which the previously displayed image remains occurs.

### SUMMARY OF THE INVENTION

Accordingly, an object of the present invention is to solve at least the problems and disadvantages of the background art.

An object of the present invention is to provide a plasma display driving apparatus that can prevent deterioration of a phosphor and improve afterimage and brightness by improving a driving waveform when a still image is displayed and a driving method thereof.

According to an aspect of the present invention, there is provided a plasma display driving apparatus including: a panel formed with a scan electrode, a sustain electrode, and an address electrode; and a driver for varying a rising time or falling time of sustain pulses applied to at least one of the scan electrode and the sustain electrode when the same image is repeatedly displayed in the panel during at least two frames.

According to another aspect of the present invention, there is provided a driving method of a plasma display apparatus, the method including: applying data pulses to an address electrode during an address period; and applying sustain pulses to at least one of a scan electrode and a sustain electrode during a sustain period, wherein a rising time or falling time of sustain pulses applied during the first frame is dissimilar to a rising time or falling time of sustain pulses applied during the second frame when the same image is repeatedly displayed in the panel during at least two frames.

According to another aspect of the present invention, there is provided a driving method of a plasma display apparatus, the method including: applying data pulses to an address electrode during an address period; and applying sustain pulses to at least one of a scan electrode and a sustain electrode during a sustain period, wherein if data pulses applied to the address electrode during a first frame and the data pulses applied to the address electrode during a second frame are substantially equal, a rising time or falling time of sustain pulses applied during the first frame is dissimilar to a rising time or falling time of sustain pulses applied during the second frame.

### BRIEF DESCRIPTION OF THE DRAWINGS

The invention will be described in detail with reference to the following drawings in which like numerals refer to like elements.

FIG. 1 is a view illustrating a driving circuit board of a conventional plasma display apparatus;

FIG. 2 is a diagram illustrating a driving waveform of a conventional plasma display apparatus;

FIG. 3 is a diagram illustrating the number of sustain pulses which are varied in an ISM mode by a plasma display driving apparatus according to the present invention;

FIG. 4 is a diagram illustrating an example of sustain pulses supplied to the plasma display apparatus according to the present invention for each frame in a still image;

FIGS. 5A to 5C are diagrams illustrating an embodiment which varies a rising time or falling time of sustain pulses applied to the plasma display apparatus according to the present invention;

FIG. 6 is a flowchart illustrating a first embodiment of a driving method of the plasma display apparatus according to the present invention;

FIG. 7 is a flowchart illustrating a second embodiment of a driving method of the plasma display apparatus according to the present invention;

FIGS. 8A to 8D are diagrams illustrating an embodiment of sustain pulses according to a driving method of the plasma display apparatus of the present invention; and

FIG. 9 is a flowchart illustrating a third embodiment of a driving method of the plasma display apparatus according to the present invention.

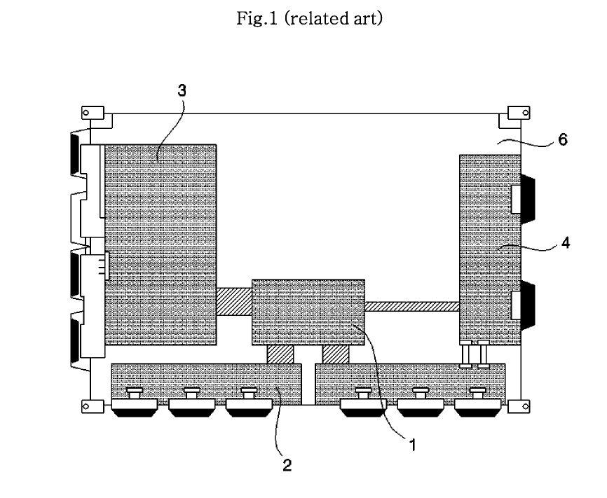

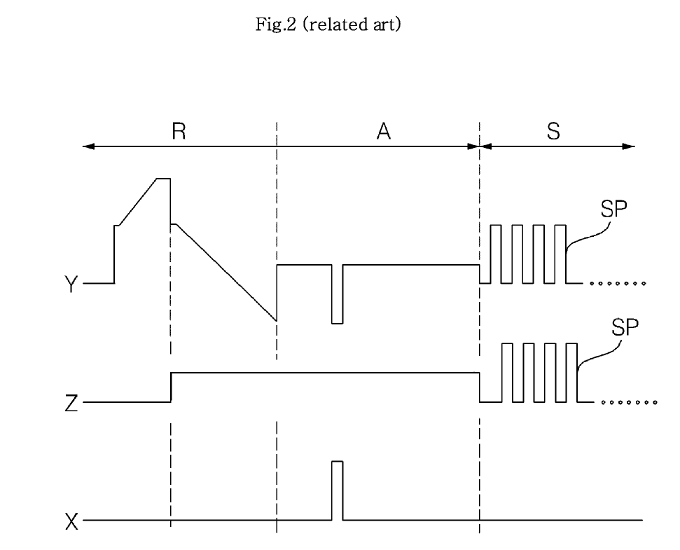

### DETAILED DESCRIPTION OF PREFERRED EMBODIMENTS

Hereinafter, a plasma display apparatus according to the present invention will be described in detail with reference to the accompanying drawings.

The plasma display apparatus according to the present invention is provided with a module including a plurality of address electrodes (X) arranged in a column direction and a plurality of scan electrodes (Y) and sustain electrodes (Z) arranged in a row direction. The scan electrode is formed to correspond to each sustain electrode and the ends of the sustain electrode are connected to each other to apply an equal voltage.

The module is formed by coupling a front panel in which the scan electrode (Y) and the sustain electrode (Z) are alternately horizontally formed and a rear panel in which the address electrode (X) is formed. The scan electrode and sustain electrode and the address electrode are arranged to opposite to each other at a discharge space therebetween so that the scan electrode and sustain electrode vertically intersect the address electrode. A discharge space at the intersection of the scan electrode and sustain electrode and the address electrode forms one basic discharge cell.

The plasma display apparatus is driven by dividing one frame with one or more subfield having the different discharge number in order to represent gray scale and the subfield is largely composed of a reset period (R), an address period (A), and a sustain period (S).

In the reset period (R), a high voltage is uniformly applied to all discharge cells regardless of on/off of a discharge cell in the previous subfield. In order to put all discharge cells in the same state, the discharge cell is initialized by applying a high voltage of 250V or more to the scan electrode (Y) and a lamp waveform is mainly used to improve contrast.

In the address period (A), image writing is performed in each discharge cell. At the same timing, data pulses are applied to the address electrode (X) and scan pulses are applied to the scan electrode (Y), thereby generating an address discharge. Accordingly, a cell to be performed a discharge is selected.

In the sustain period (S), a sustain discharge is generated by alternately applying a pulse (Vs) signal having opposite polarity to the scan electrode (Y) and the sustain electrode (Z), thereby displaying a screen.

In order to represent 256-level gray scale, one frame (16.7 ms) is divided into 8 or more subfields in the plasma display apparatus. The reset period (R) and the address period (A) of each subfield are equal, but the sustain period (S) has the different number of sustain pulses in each subfield, whereby the number of a sustain discharge generating in the subfield becomes different.

In the sustain period (S), the maximum number of a sustain discharge increases in a ratio of 2ⁿ in the each subfield. As the number of the sustain pulse increases, the maximum number of a sustain discharge in the sustain period increases, thereby emitting bright light.

In the first embodiment of a plasma display driving apparatus according to the present invention, the apparatus includes a driver for varying the number of the sustain pulses applied to at least one of the scan electrode and the sustain electrode when an image that is displayed in the panel is a still image.

The driver applies sustain pulses of gradually reduced number to the scan electrode and the sustain electrode as a time of displaying a still image is lengthened.

For this reason, when the same screen is displayed during a reference time or more, the driver judges the displayed image as a still image. The driver judges whether a still image is displayed or moving image is displayed with a method of judging whether the same image is displayed during the previously set time or more by driving a timer or whether a frame having the same image data during the previously set frame time are displayed in the set number or more by signals ( [symbol] [symbol] ) applied to each discharge cell during an address period (A).

Another method of judging whether it is a still image is to judge whether the same image is repeatedly displayed during at least two or more frames in the panel.

Furthermore, it may be judged whether a still image is displayed by checking whether data pulses of a temporally preceding first frame and a following second frame are applied in substantially equal timing.

In this case, it is judged whether a still image is displayed by checking whether data pulses applied to subfields of the same order in the first frame and the second frame are equal to each other during frames. That is, it is judged whether data pulses are equal to each other in all subfields constituting a frame by checking whether the data pulses applied to subfields of the same order in the first frame and the second frame are equal to each other in all of a first subfield to a last subfield, whereby it is judged whether it is a still image.

A reference of judging whether an image displayed in the driver is a still image is not limited to methods described in this specification and various methods can be used.

If it is judges that a still image is displayed, the driver varies the number of sustain pulses of a unit frame. For example, it is assumed that 1000 sustain pulses are applied to perform a sustain discharge of 1000 times to the maximum during a unit frame.

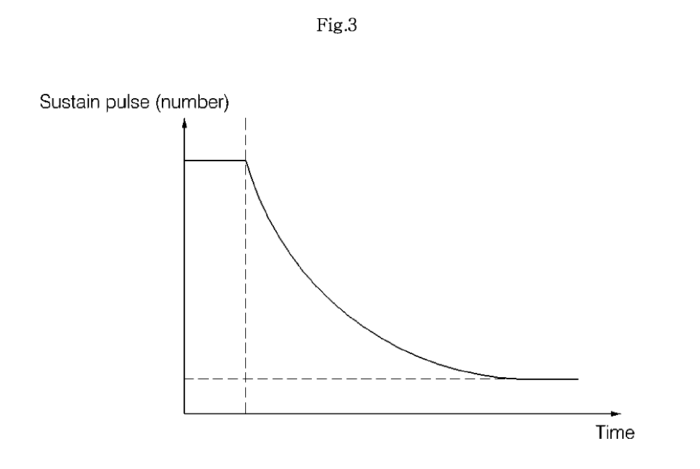

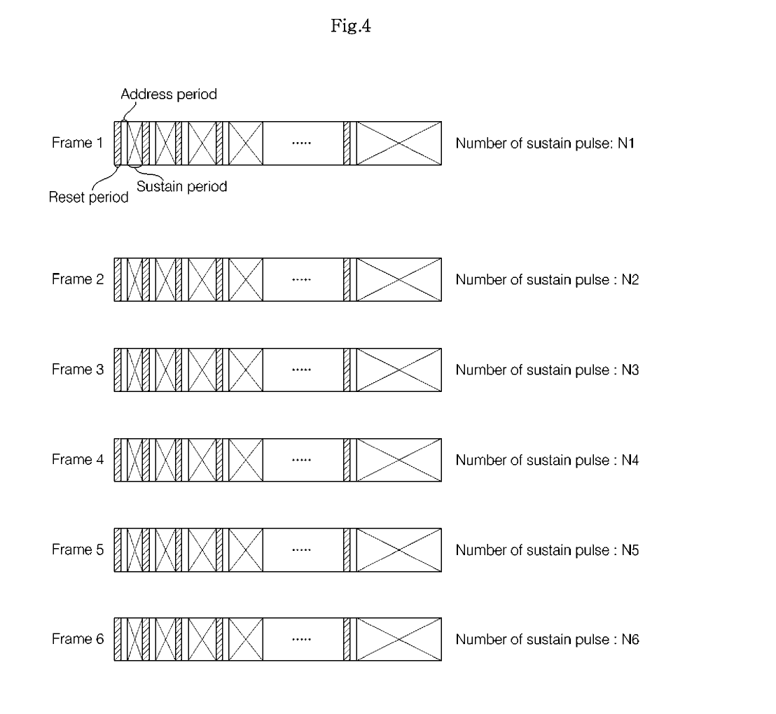

FIG. 3 is a diagram illustrating the number of sustain pulses which are varied by a plasma display driving apparatus according to the present invention. FIG. 4 is a diagram illustrating the number of sustain pulses applied to the plasma display apparatus according to the present invention for each frame.

As shown in FIG. 3, when a still image is displayed during a predetermined time, the driver varies the number of sustain pulses so that the number of sustain pulses of one frame gradually decreases.

Specifically, referring to each frame, as shown in FIG. 4, it is assumed that the number (N1) of sustain pulses applied during a first frame is 1000 (Frame 1). Thereafter, when each cell represents the same gray scale during a predetermined reference time (Frame 1 to 3) or the reference number or more, the driver gradually reduces the number of sustain pulses. That is, when the number (N2) of sustain pulses applied during a second frame and the number (N3) of sustain pulses applied during a third frame are 1000 as in an existent case and the same image is continuously displayed, the total numbers (N4 to N6) of sustain pulses applied during each frame gradually decrease in the following frames (frame 4 to 6). For example, the number gradually decreases as in N4=800, N5=500, and N6=200. That is, a deterioration phenomenon of a phosphor is prevented upon performing a sustain discharge by reducing the number of sustain discharge generating per unit frame (Frame 4 to 6).

By gradually reducing the number of sustain pulses as time goes by, the driver reduces the number of sustain pulses so that approximately 200 sustain pulses are applied in a last frame in which the same image is displayed (Frame 6). If a sustain discharge is performed very few because the number of sustain pulses that is applied during one frame is too small, particles for a discharge are generated too few when a discharge is performed. Accordingly, when another image is displayed, priming particles are not fully generated during a reset period (R) and thus brightness characteristic may be lowered.

Therefore, it is preferable to adjust the number of applied sustain pulses so that at least 200 times of sustain discharge may be performed by reducing the number of sustain pulses.

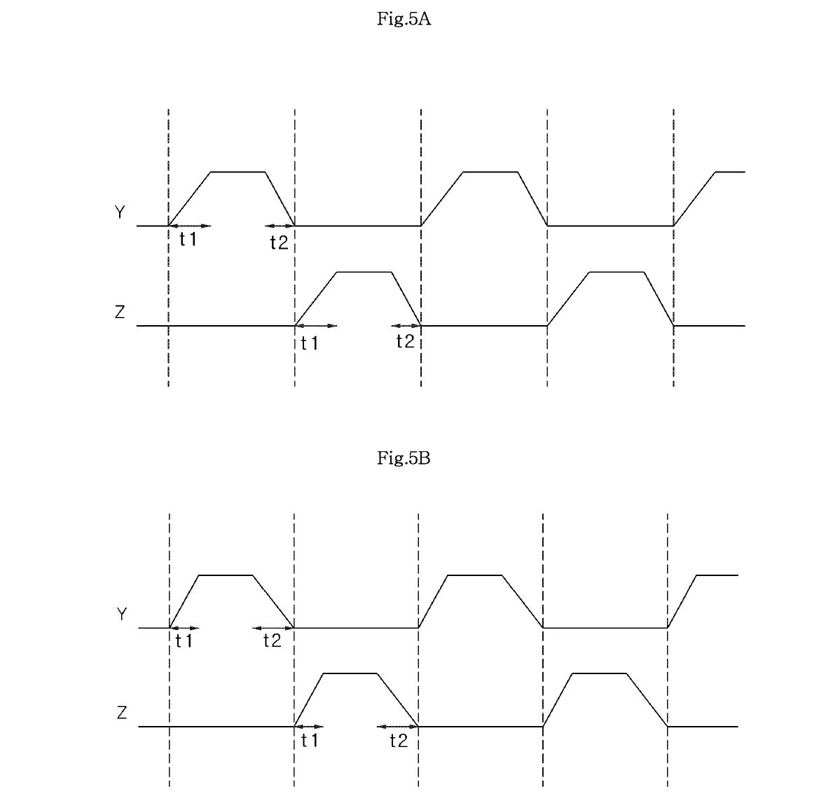

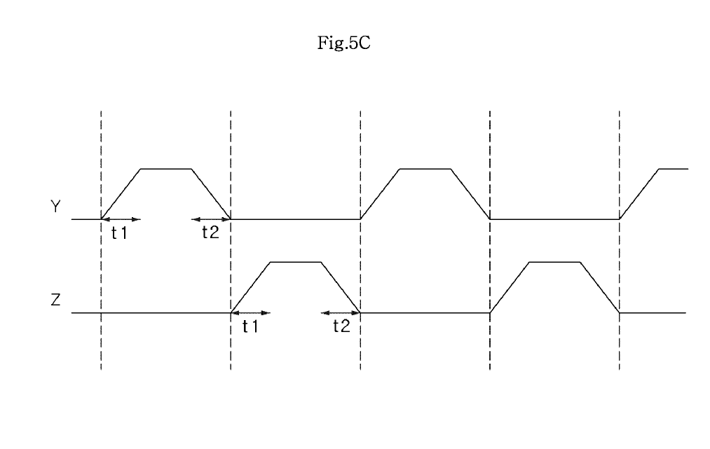

FIGS. 5A to 5C are diagrams illustrating an embodiment which varies a rising time or falling time of sustain pulses applied to the plasma display apparatus according to the present invention.

Referring to FIGS. 5A to 5C, in a second embodiment of the plasma display driving apparatus according to the present invention, when an image displayed to the panel is a still image, the driver varies a rising time or falling time of the sustain pulses applied to the scan electrode and the sustain electrode to be longer.

In general, when a plasma display apparatus is driven, an effective current used upon performing a discharge can be not reduced, but a reactive current applied to the scan electrode (Y) and the sustain electrode (Z) in order to generate a discharge is recovered and reused. That is, after being stored in a separate capacitor, the recovered reactive current is reused when sustain pulses are applied to the scan electrode and the sustain electrode during the sustain period (S).

When a sustain voltage for generating a discharge is applied to the scan electrode (Y) and the sustain electrode (Z), electric charges stored in the capacitor are applied to the scan electrode and the sustain electrode, so that energy can be recovered.

The recovered energy is used as a rising voltage or falling voltage of sustain pulses.

At this time, if a rising time of the sustain voltage (Vs) is lengthened, the sustain period of the sustain voltage decreases, whereby intensity of a discharge is weakened. On the contrary, if a rising time of the sustain voltage is shortened, a sustain period of sustaining a high potential of sustain pulses is lengthened and many charged particles are generated, whereby a strong discharge is generated and thus brightness increases. However, deterioration of a phosphor is generated due to a strong discharge, whereby a lifetime of a plasma display apparatus is affected and a cell in which a discharge is generated has more charged particles than surrounding cells, so that an afterimage increases.

Referring to FIGS. 5A to 5C, when sustain pulses are applied to the scan electrode (Y) and the sustain electrode (Y) as a still image is displayed, the driver adjusts a rising time (t1:Er-up time) or a falling time (t2:ER-down time) of the sustain voltage (Va) to be long.

That is, the driver varies a rising time or falling time of applied sustain pulses to be lengthened when a still image is displayed than when a moving image is displayed.

The driver can adjust a rising time of the sustain pulses to be longer than a falling time (FIG. 5A), a falling time of the sustain pulses to be longer than a rising time (FIG. 5B), or both of a rising time and a falling time of the sustain pulses to be long (FIG. 5C).

In general, since a rising time of sustain pulses is 400 ns, the driver adjusts so that a rising time or falling time of the sustain pulses is longer than 400 ns while reducing the number of sustain pulses during one frame when a still image is displayed.

That is, if a rising time or falling time of the sustain pulses is lengthened, a sustain period of the sustain pulses is shortened. Accordingly, when a sustain discharge is generated, intensity of a discharge is weakened and deterioration of a phosphor decreases and thus an afterimage decreases.

In a third embodiment of the plasma display apparatus according to the present invention, when a still image is continued during a predetermined time or more, the driver adjusts a rising time or falling time of the sustain pulse to be longer than when a moving image is displayed while reducing the number of sustain pulses, whereby an afterimage improvement effect can be maximized.

An afterimage is effectively improved as a rising time or falling time of sustain pulses is lengthened or a sustain period of sustaining a low potential of sustain pulses is lengthened. As described above, if the number of sustain pulses decreases, a sustain period of sustaining a low potential of sustain pulses and a sustain period of sustaining a high potential of sustain pulses are lengthened. Therefore, if the number of sustain pulses decreases, a rising time or falling time of the sustain pulses can be varied to be longer than when a moving image is displayed and if a sustain period of sustaining a low potential increases, a weak discharge is generated, whereby deterioration of a phosphor can be prevented.

Although an afterimage improvement effect is improved as a rising time or falling time of the sustain pulses is lengthened, a width of the sustain pulses is limited. Therefore, if a rising time or falling time of the sustain pulses is excessively long, a sustain period of the sustain pulses is excessively shortened or not existed, thereby generating an erroneous discharge. Accordingly, a rising time or falling time of the sustain pulses is set not to exceed 700 ns.

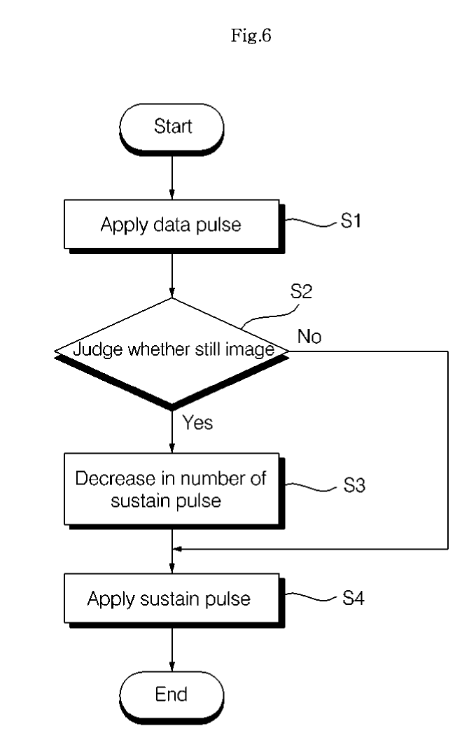

FIG. 6 is a flowchart illustrating a first embodiment of a driving method of the plasma display apparatus according to the present invention. The first embodiment of a driving method of the plasma display apparatus according to the present invention having the above-mentioned construction will be described with reference to FIG. 6.

First, data pulses are applied to an address electrode during an address period (S1).

Next, it is judged whether a displayed image is a still image (S2). In a still image, as the same frame is displayed during a reference time or more or the reference number or more, gray scale represented in each discharge cell is equal in every frame. That is, a discharge is continuously generated in a cell in which a discharge is generated in every frame and a discharge is not continuously generated in a cell in which a discharge is not generated.

Therefore, it is determined that a still image is displayed when a frame having the same image data of a reference time or more or a reference number or more is displayed.

Other method of judging such a still image is to judge by comparing two frames having the temporal front and rear relationship. If each data pulse is applied in substantially equal timing in each subfield by comparing data pulses applied to the temporally preceding first frame and data pulses applied to the second frame, images of the first frame and the second frame can be judged as substantially an equal image.

For example, it is judged whether a still image is displayed by checking whether data pulses applied to subfields of the same order in the first frame and the second frame are equal to each other during frames. That is, it is judged whether data pulses are equal to each other in all subfields constituting a frame by checking whether the data pulses applied to subfields of the same order in the first frame and the second frame are equal to each other in all of a first subfield to a last subfield, whereby it is judged whether it is a still image.

According to such a reference, if the same image is continuously displayed during a predetermined time or more, the image is judged as a still image.

If a still image is displayed, the number of sustain pulses of the first frame and the second frame is adjusted to be different (S3). The number of entire sustain pulses in the second frame displayed later is adjusted to be fewer than that of sustain pulses of the first frame. To adjust the number of the sustain pulses to be few will be described with reference to FIGS. 3 and 4.

Here, the number of sustain pulses is the total number of sustain pulses applied during one frame. When a moving image is displayed, more than 1000 sustain pulses are generally applied during one frame.

Therefore, the number of sustain pulses applied during one frame when a still image is displayed is set to be smaller than that of sustain pulses applied during one frame when a moving image is displayed.

Furthermore, the number of sustain pulses applied during each frame is set to gradually decrease as time goes by and sustain pulses applied during one frame are set to be 200 or more.

When a still image is displayed, deterioration of a phosphor is aggravated because it is displayed so that all discharge cells may have equal brightness in every frame. Therefore, in order to remove an afterimage due to deterioration of a phosphor, the number of sustain pulses is reduced so that the maximum discharge number of sustain pulses gradually decreases

As the number of sustain pulses applied during one frame decreases, deterioration of a phosphor decreases and an afterimage is improved. However, if the number of sustain pulses excessively decreases, wall charges or priming particles are not fully generated within a discharge cell, whereby brightness may be deteriorated. Accordingly, the number of sustain pulses applied during one frame is set to be at least 200.

During a sustain period, the sustain pulses having the number determined as described above are alternately applied to the scan electrode and the sustain electrode (S4).

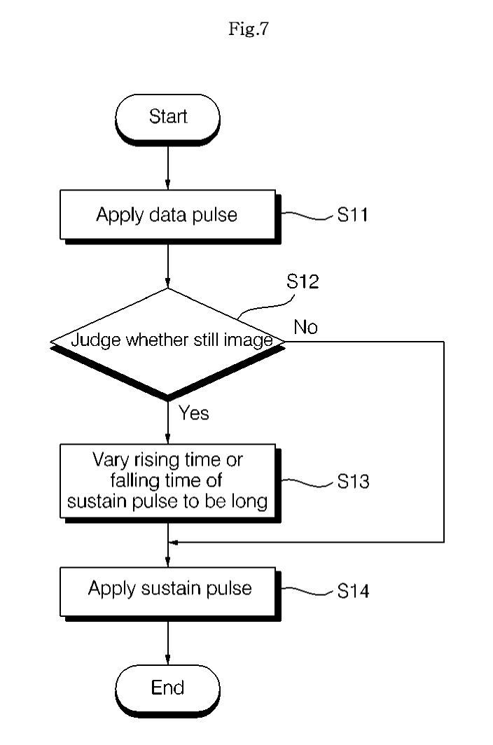

FIG. 7 is a flowchart illustrating a second embodiment of a driving method of the plasma display apparatus according to the present invention. The second embodiment of a driving method of the plasma display driving apparatus according to the present invention having the above-mentioned construction will be described with reference to FIG. 7.

First, data pulses are applied to an address electrode during an address period (S11).

Next, it is judged whether a displayed image is a still image (S12). A method of judging whether it is a still image is substantially equal to the first embodiment and thus descriptions thereof will be omitted.

When a display image is a still image, a rising time or falling time of sustain pulses is varied (S13). At this time, any one of a rising time or falling time of the sustain pulses is lengthened or both of a rising time or falling time of the sustain pulses can be varied to be lengthened. That is, a rising time or falling time of sustain pulses of the second frame which is displayed later than a rising time or falling time of sustain pulses of the first frame which is first displayed can be set to be lengthened.

In this case, as a rising time of sustain pulses is lengthened, an afterimage improvement effect is improved, whereby a rising time of the sustain pulses can be set to be longer than a falling time in the second frame. This is because a rising time of sustain pulses has a great influence on an afterimage improvement effect.

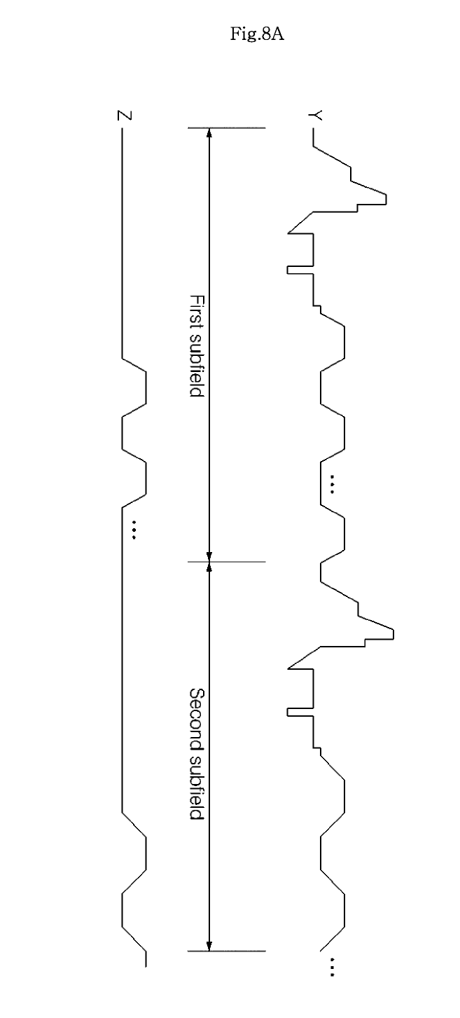

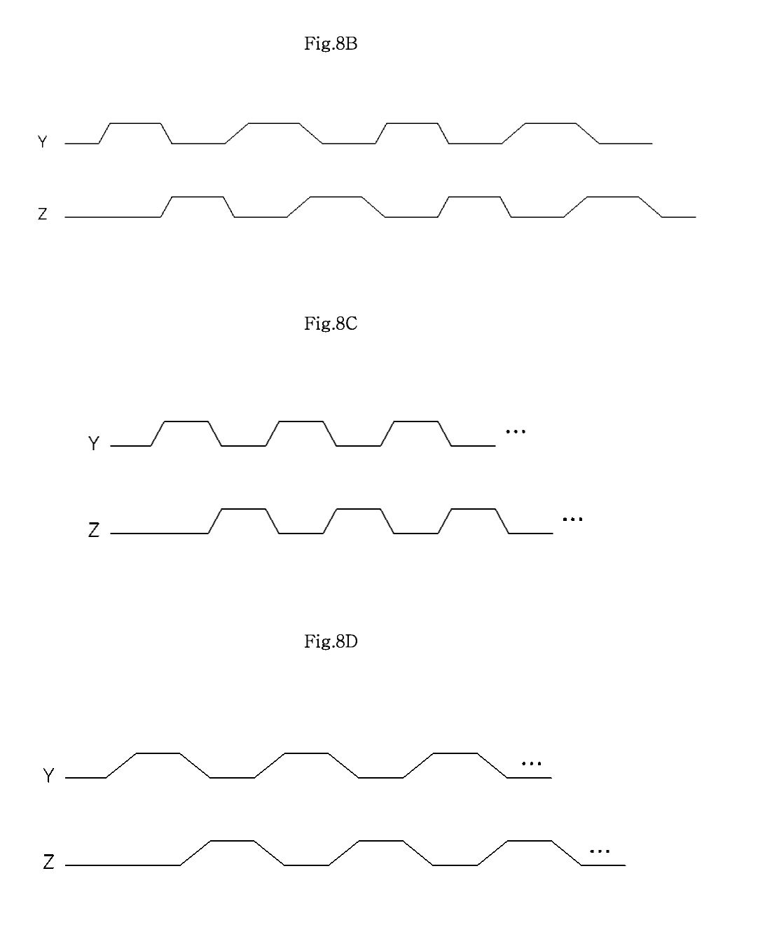

FIGS. 8A to 8D are diagrams illustrating a specific embodiment of a sustain pulse according to a driving method of the plasma display apparatus of the present invention.

Referring to FIGS. 8A to 8D, a subfield constituting one frame can set to have a different sustain rising or falling time. That is, as shown in FIG. 8A, a rising time of sustain pulses of the first subfield and the second subfield constituting one frame variable can be varied to be different from each other. At this time, as the number of sustain pulses applied during one subfield increases, weak discharge is generated and thus an afterimage is improved if a rising time of sustain pulses may be varied to be lengthened.

Furthermore, as shown in FIG. 8B, an afterimage can be improved by varying rising times of sustain pulses to become different in the same subfield. Because a sustain pulse applied to the first and a sustain pulse applied to the last have a great influence on discharge, a rising time or falling time of sustain pulses in the same subfield is varied except the sustain pulse applied to the first and the sustain pulse applied to the last.

Furthermore, a rising time or falling time of sustain pulses can be varied so that a rising time or falling time of sustain pulses of the first frame and a rising time or falling time of sustain pulses of the second frame are different from each other. At this time, as shown in FIGS. 8C and 8D, a rising time or falling time (8D) of sustain pulses of the second frame is set to be longer than a rising time or falling time of sustain pulses of the first frame (8C).

That is, when the number of sustain pulse of the second frame decreases, compared to that of the first frame and at the same time, a rising time or falling time of sustain pulses of the second frame is varied to be longer than a rising time or falling time of sustain pulses of the first frame, weak discharge is generated and deterioration of a phosphor is not generated, whereby an afterimage is improved.

Here, because a rising time or falling time of general sustain pulses is about 400 ns, a rising time or falling time of the sustain pulses is varied to be 400 ns or more. As a rising time or falling time of the sustain pulses is lengthened, an afterimage improvement effect is improved. However, if a rising time or falling time of the sustain pulses is excessively lengthened, an erroneous discharge may be generated due to too weak discharge. Accordingly, a rising time or falling time of sustain pulses is set to vary in a range of 400 ns to 700 ns.

Specifically, as a sustain period of sustaining a low potential of sustain pulses is lengthened, a weak discharge is generated and thus an afterimage is improved. When the sustain pulses is varied so that a sustain period of sustaining a low potential of the sustain pulses is lengthened while reducing the number of the sustain pulses sustain pulse, an afterimage improvement effect can be maximized.

That is, when a rising time or falling time of the sustain pulses is varied so that a sustain period of sustaining a low potential of the sustain pulses of a next frame is longer than a sustain period of sustaining a low potential of the sustain pulses of the previous frame, a weak discharge is generated during a sustain period and deterioration of a phosphor decreases, so that an afterimage can be removed.

Finally, during a sustain period, sustain pulses having the rising time or falling time are alternately applied to the scan electrode and the sustain electrode (S14).

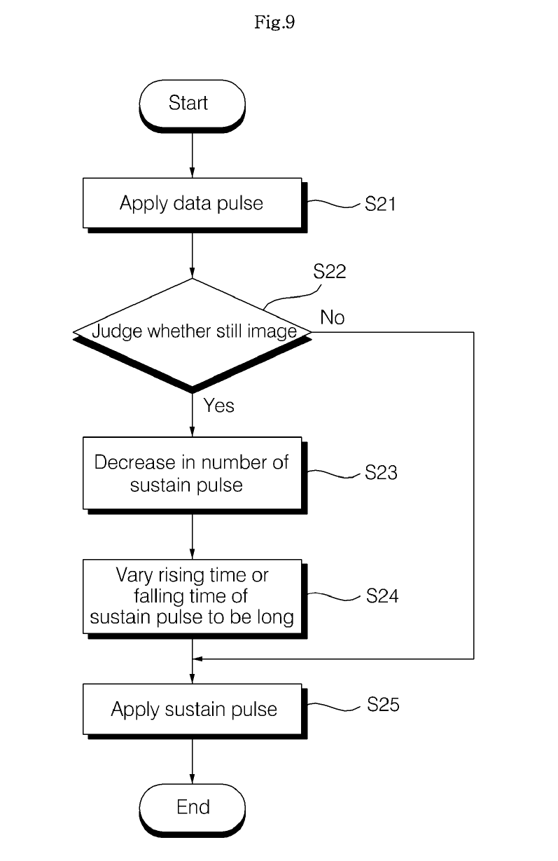

FIG. 9 is a flowchart illustrating a third embodiment of a driving method of the plasma display apparatus according to the present invention. The third embodiment of a driving method of the plasma display driving apparatus according to the present invention having the above-mentioned construction will be described with reference to FIG. 9.

First, data pulses are applied to an address electrode during an address period (S21).

Next, it is judged whether a displayed image is a still image (S22). A method of judging whether it is a still image is substantially equal to the first embodiment and thus descriptions thereof will be omitted.

If a still image is displayed, the number of sustain pulses of the temporally preceding first frame and the following second frame is set to be different (S23). A method of varying the number of the sustain pulses is substantially equal to the first embodiment and thus descriptions thereof will be omitted.

As described above, after varying the number of the sustain pulses, a rising time or falling time of the sustain pulses is varied (S24). To vary a rising time or falling time of the sustain pulses is substantially equal to the second embodiment and thus descriptions thereof will be omitted.

Finally, during a sustain period, sustain pulses having a rising time or falling time are alternately applied to the scan electrode and the sustain electrode (S25).

That is, the third embodiment of a driving method of the plasma display apparatus according to the present invention is a combination of the first embodiment and the second embodiment.

A plasma display apparatus and a driving method thereof according to the present invention having a construction described above, intensity of a discharge is weakened by reducing the number of a sustain discharge and at the same time, setting a rising time or falling time of sustain pulses to be long when the same image is displayed during a fixed time, so that deterioration of a phosphor is prevented and an afterimage and brightness are improved.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A plasma display driving apparatus comprising:
a panel formed with a scan electrode, a sustain electrode, and an address electrode; and
a driver for varying a rising time or falling time of sustain pulses applied to at least one of the scan electrode and the sustain electrode when the same image is repeatedly displayed in the panel during at least two frames.

2. The plasma display driving apparatus as claimed in claim 1, wherein the driver varies the number of sustain pulses when the same image is repeatedly displayed in the panel during at least two frames and reduces the number of sustain pulses of a frame as the same image is repeatedly displayed in the panel.

3. The plasma display driving apparatus as claimed in claim 1, wherein the driver varies the rising time or falling time of sustain pulses of a frame to be longer as the same image is repeatedly displayed in the panel.

4. The plasma display driving apparatus as claimed in claim 1, wherein the rising time or falling time of the sustain pulses ranges from 400 ns to 700 ns.

5. A driving method of a plasma display driving apparatus, the method comprising:
applying data pulses to an address electrode during an address period; and
applying sustain pulses to at least one of a scan electrode and a sustain electrode during a sustain period,
wherein a rising time or falling time of sustain pulses applied during the first frame is dissimilar to a rising time or falling time of sustain pulses applied during the second frame when the same image is repeatedly displayed in the panel during at least two frames.

6. The driving method as claimed in claim 5, wherein the number of the sustain pulses is varied when the same image is repeatedly displayed in the panel during at least two frames.

7. The driving method as claimed in claim 6, wherein the number of the sustain pulses of the second frame is smaller than the number of the sustain pulses of the first frame.

8. The driving method as claimed in claim 5, wherein the rising time of the sustain pulses is longer than the falling time thereof.

9. The driving method as claimed in claim 5, wherein the rising time or falling time of the sustain pulses of the second frame is longer than the rising time or falling time of the sustain pulses of the first frame.

10. The driving method as claimed in claim 5, wherein the rising time or falling time of the first and second frames is approximately from 400 ns to 700 ns.

11. The driving method as claimed in claim 5, wherein the falling time of the sustain pulses of the second frame is longer than the falling time of the sustain pulses of the first frame.

12. The driving method as claimed in claim 5, wherein a rising time or falling time of sustain pulses of a first subfield or second subfield constituting the first frame or second frame is different from each other.

13. The driving method as claimed in claim 5, wherein a rising time or falling time of a first sustain pulse and a second sustain pulse is different from each other in at least one subfield among subfields constituting the first frame or second frame.

14. The driving method as claimed in claim 5, wherein a sustain period of sustaining a low potential of at least one sustain pulse in the first frame is shorter than a sustain period of sustaining a low potential of at least one sustain pulse in the second frame.

15. A driving method of a plasma display apparatus, the method comprising:
applying data pulses to an address electrode during an address period; and
applying sustain pulses to at least one of a scan electrode and a sustain electrode during a sustain period,
wherein if data pulses applied to the address electrode during a first frame and the data pulses applied to the address electrode during a second frame are substantially identical, a rising time or falling time of sustain pulses applied during the first frame is dissimilar to a rising time or falling time of sustain pulses applied during the second frame.

16. The driving method as claimed in claim 15, wherein if data pulses applied to the address electrode during the first frame and the data pulses applied to the address electrode during the second frame are identical, the number of sustain pulses applied during the first frame is dissimilar to the number of sustain pulses applied during the second frame.

17. The driving method as claimed in claim 16, wherein the number of sustain pulses applied during the second frame is smaller than the number of sustain pulses applied during the first frame.

18. The driving method as claimed in claim 15, wherein a rising time or falling time of sustain pulses applied during the second frame is longer than a rising time or falling time of sustain pulses applied during the first frame.

19. The driving method of claim 15, wherein the rising time or falling time of sustain pulses of the first and second frames is approximately from 400 ns to 700 ns.

20. The driving method as claimed in claim 15, wherein if the data pulses applied from identical subfields of the first frame and the second frame to the address electrode are substantially equal, a rising time or falling time of sustain pulses applied during the first frame is dissimilar to a rising time or falling time of sustain pulses applied during the second frame.
